(19) United States
(12) Patent Application Publication
(10) Pub. No.: US 2013/0291300 A1
(43) Pub. Date: Nov. 7, 2013

(54) FRAME LATCHING ASSEMBLIES

(71) Applicant: INVACARE CORPORATION, Elyria, OH (US)

(72) Inventors: Robert R. Bly, Wellington, OH (US); Kevin S. Wysocki, Grafton, OH (US)

(73) Assignee: INVACARE CORPORATION, Elyria, OH (US)

(21) Appl. No.: 13/826,799

(22) Filed: Mar. 14, 2013

Related U.S. Application Data
(60) Provisional application No. 61/643,421, filed on May 7, 2012.

(51) Int. Cl. F16B 2/18; A47C 19/00

(52) U.S. Cl. CPC F16B 2/185; A47C 19/005
USPC 5/400; 24/593.1; 29/428

(57) ABSTRACT

An assembly includes a first and second frame members and a latch. A second interlocking feature of the second frame member is configured to interlock with a first interlocking feature of the first frame member when the second frame member is assembled with the first frame member and the second frame member is moved with respect to the first frame member from a first vertical position to a second vertical position. The latch is secured to the first frame member and is horizontally movable between a locked position and an unlocked position. In the locked position, the latch engages a catch portion of the second frame member to secure the second frame member in the second vertical position. In the unlocked position, the latch disengages from the catch portion of the second frame member to permit movement of the second frame member to the first vertical position.

### CROSS-REFERENCE TO RELATED APPLICATION

This application claims priority to and the benefit of U.S. Provisional Patent Application Ser. No. 61/643,421, entitled “FRAME LATCHING ASSEMBLIES” and filed May 7, 2012, the entire disclosure of which is incorporated herein by reference.

### BACKGROUND

Headboards and footboards used, for example, with home care and long term care beds, are commonly attached to the ends of a bed using removable fasteners (e.g., brackets secured to each other using screws or bolts) to allow for frequent disassembly and reassembly of the beds.

### SUMMARY

The present application discloses exemplary embodiments of systems and assemblies suitable for beds and other devices requiring assembly and disassembly. In one embodiment, a latching arrangement for use with a variety of assemblies, including, for example, a bed, for detachably coupling a first component of the assembly (e.g., a bed frame) with a second component of the assembly (e.g., a headboard or footboard). In one exemplary embodiment, a latching arrangement includes first and second frame members. The first frame member includes one or more first interlocking features that interlock with one or more second interlocking features of the second frame member. The arrangement also includes a latch connected with the first frame member and movable to a locked position for engagement with a catch portion of the second frame member, thereby securing the first interlocking feature in interlocking engagement with the second interlocking feature for secure attachment of the first and second frame members.

Accordingly, in another exemplary embodiment, an assembly includes a first frame member, a second frame member, and a latch. The first frame member includes a first interlocking feature, and the second frame member includes a second interlocking feature. The second interlocking feature is configured to interlock with the first interlocking feature when the second frame member is assembled with the first frame member and the second frame member is moved with respect to the first frame member from a first vertical position to a second vertical position. The latch is secured to the first frame member and is horizontally movable between a locked position and an unlocked position. In the locked position, the latch engages a catch portion of the second frame member to secure the second frame member in the second vertical position. In the unlocked position, the latch disengages from the catch portion of the second frame member to permit movement of the second frame member to the first vertical position.

In another exemplary embodiment, a bed assembly includes a bed frame, an end board, and a cam member. The bed frame includes an end bracket portion having at least one flanged tab portion. The end board includes a mounting portion having at least one slotted portion configured to interlock with the at least one flanged tab portion when the end board is assembled with the bed frame and is moved with respect to the bed frame from a first vertical position to a second vertical position. The cam member is secured to one of the bed frame and the end board, and is pivotable about a lateral horizontal axis substantially parallel to an interface between the first and second frame members between a locked position, in which the cam member engages a recess in the other of the bed frame and the end board to secure the end board in the second vertical position, and an unlocked position in which the cam member disengages from the recess to permit movement of the end board to the first vertical position.

In still another exemplary embodiment, a method of releasably attaching an end board to a bed frame is provided. The end board is positioned at a first vertical position such that at least one flanged tab extending from the bed frame aligns with a corresponding slotted portion in the end board. The at least one flanged tab is inserted into the corresponding slotted portion. The end board is moved from the first vertical position to a second vertical position such that the at least one flanged tab interlocks with the corresponding slotted portion to secure the end board to the bed frame. A cam member secured to one of the bed frame and the end board is pivoted to a locked position in which the cam member engages a corresponding recess in the other of the bed frame and the end board to prevent movement of the end board from the second vertical position to the first vertical position.

In another exemplary embodiment, a bed assembly includes a frame, an end member, and means for interlocking a portion of the end member to a portion of the frame in a first vertical position, thereby supporting the frame above a floor, and for releasing the portion of the end member from the portion of the frame in a second vertical position. The assembly further includes means for securing the frame in the first vertical position.

In yet another exemplary embodiment, a bed assembly includes a frame having a first interlocking portion, and an end member having a second interlocking portion for interlocking with the first interlocking portion when the frame is in a first vertical position and for releasing from the first interlocking portion when the frame is in a second vertical position. The frame includes a latch for securing the frame in the first vertical position.

In still another exemplary embodiment, a bed end includes means for interlocking a portion of the bed end to a portion of a bed frame in a first vertical position and for releasing the portion of the end member from the portion of the bed frame in a second vertical position. The bed end further includes means for receiving a latch extending from the bed frame to secure the bed frame in the first vertical position.

In another exemplary embodiment, a bed end includes an interlocking portion for interlocking with a portion of a bed frame in a first vertical position and for releasing from the portion of the bed frame in a second vertical position, and a catch portion for receiving a latch extending from the bed frame to secure the bed frame in the first vertical position.

In another exemplary embodiment, a bed frame includes means for interlocking a portion of the bed frame to a portion of a bed end in a first vertical position and for releasing the portion of the bed frame from the portion of the bed end in a second vertical position, and means for latching the bed frame to the bed end to secure the bed frame in the first vertical position.

In still another exemplary embodiment, a bed frame includes an interlocking portion for interlocking with a portion of a end in a first vertical position and for releasing from the portion of the bed end in a second vertical position, and a latch for engaging a catch portion of the bed end to secure the bed frame in the first vertical position.

### BRIEF DESCRIPTION OF THE DRAWINGS

Further features and advantages will become apparent to those of ordinary skill in the art to which the invention pertains from a reading of the following description together with the accompanying drawings, in which:

FIG. 1A is a cross-sectional schematic view of a cam locking assembly according to an exemplary embodiment, shown in a locked condition;

FIG. 1B is a cross-sectional schematic view of the assembly of FIG. 1A, shown in an unlocked condition;

FIG. 2A is a cross-sectional schematic view of a cam locking assembly according to another exemplary embodiment, shown in a locked condition;

FIG. 2B is a cross-sectional schematic view of the assembly of FIG. 2A, shown in an unlocked condition;

FIG. 3 is a perspective view of a bed assembly with cam locking arrangements, according to an exemplary embodiment;

FIG. 4 is an enlarged perspective view of a cam locking arrangement of the bed assembly of FIG. 3;

FIG. 5 is a side cross-sectional view of the cam locking arrangement of FIG. 4, shown with the cam member in a locked position;

FIG. 6 is a perspective view of the bed frame end bracket and cam assembly of the bed assembly of FIG. 3; and

FIG. 7 is an enlarged perspective view of an end board mounting portion of the bed assembly of FIG. 3.

### DESCRIPTION

This Description merely describes exemplary embodiments and is not intended to limit the scope of the claims in any way. Indeed, the invention as claimed is broader than and unlimited by the exemplary embodiments, and the terms used in the claims have their full ordinary meaning.

As described herein, when one or more components are described as being connected, joined, affixed, coupled, attached, or otherwise interconnected, such interconnection may be direct as between the components (including being integrally formed with each other) or may be indirect such as through the use of one or more intermediary components. Also as described herein, reference to a “member,” “component,” or “portion” shall not be limited to a single structural member, component, or element but can include an assembly of components, members or elements.

According to one aspect of the present application, a latching arrangement is provided for use with assemblies including multiple components for which detachment and re-attachment is desired. In one such application, first and second frame members include first and second interlocking portions that are vertically movable into interlocking engagement with each other when the first frame member is assembled with the second frame member. A latch is assembled with the first frame member and is horizontally movable between a locked position and an unlocked position. When the first frame member is assembled with the second frame member and the latch is in the locked position, the latch engages a catch portion of the second frame members to limit vertical movement of the second frame member with respect to the first frame member, thereby preventing disengagement of the first and second interlocking portions and disassembly of the first and second frame members. When the latch is moved to the unlocked position, the latch disengages the catch portion to permit vertical movement of the second frame member with respect to the first frame member, thereby permitting disengagement of the first and second interlocking portions and disassembly of the first and second frame members. As used herein, movement of a second member with respect to a first member may include movement of the second member, movement of the first member (such that the position of the second member with respect to the first member changes), or movement of both first and second members.

As used herein, a frame member may include, for example, at least a portion of the component to be attached (e.g., a portion of a bed frame or end board), a bracket member for direct or indirect assembly with the component to be attached, or a combination of the bracket member and at least a portion of the component to be attached.

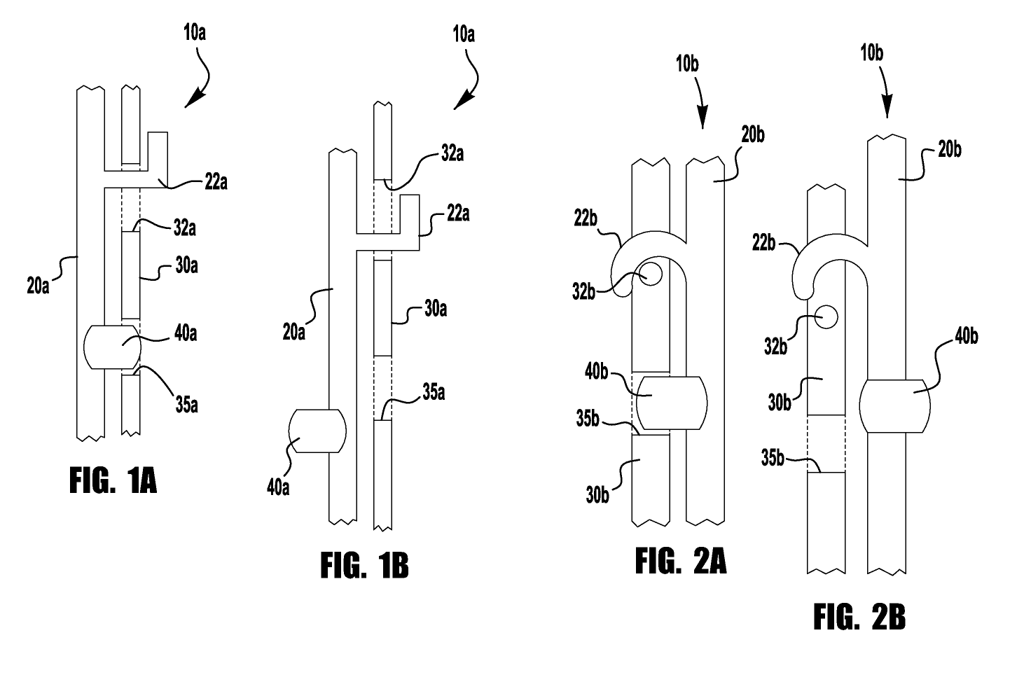

FIGS. 1A and 1B schematically illustrate an exemplary latching arrangement 10a including a first frame member 20a, a second frame member 30a, and a latch 40a. The first frame member 20a includes at least one first interlocking portion 22a that is vertically movable (e.g., by vertical movement of the first frame member 20a) into interlocking engagement with a corresponding second interlocking portion 32a of the second frame member 30a when the first frame member 20a is assembled with the second frame member 30a. The interlocking portions may be provided in many different configurations that provide for restricted horizontal movement of the first frame member 20a with respect to the second frame member 30a in a first vertical position (FIG. 1A), and permitted or unrestricted horizontal movement of the first frame member 20a with respect to the second frame member 30a in a second vertical position (FIG. 1B), which may be either raised or lowered from the first vertical position. For example, the interlocking portions may include one or more hooks, flanges, or flanged tabs (e.g., extending upward or downward), slots, fasteners, or other such means for interlocking the first frame member with the second frame member against relative horizontal movement of the first and second frame members. In the illustrated schematic example of FIGS. 1A and 1B, the first interlocking portion 22a includes a flanged tab, and the second interlocking portion 32a includes an upward extending keyed slot sized to horizontally receive the upward extending flange of the tab 22a in the second vertical position (FIG. 1B). When the first frame member 20a is moved to the first vertical position (FIG. 1A), the flanged portion of the tab 22a of the first frame member 20a interlocks with the slot 32a of the second frame member 30a to hold the first and second frame members 20a, 30a together by restricting horizontal movement of the frame members 20a, 30a with respect to each other. To separate the first and second frame members 20a, 30a, the first frame member is lowered to the second vertical position to allow withdrawal of the tab 22a from the slot 32a. In such an arrangement, the weight of the first frame member 20a may (but need not) be sufficient to lower the first frame member to the second vertical position upon disengagement of the latch 40a from the second frame member 30a. In another embodiment, the flanged tab may extend downward to interlock with a downward extending keyed slot, with the first frame member being raised to a second vertical position to allow withdrawal of the flanged tab from the slot.

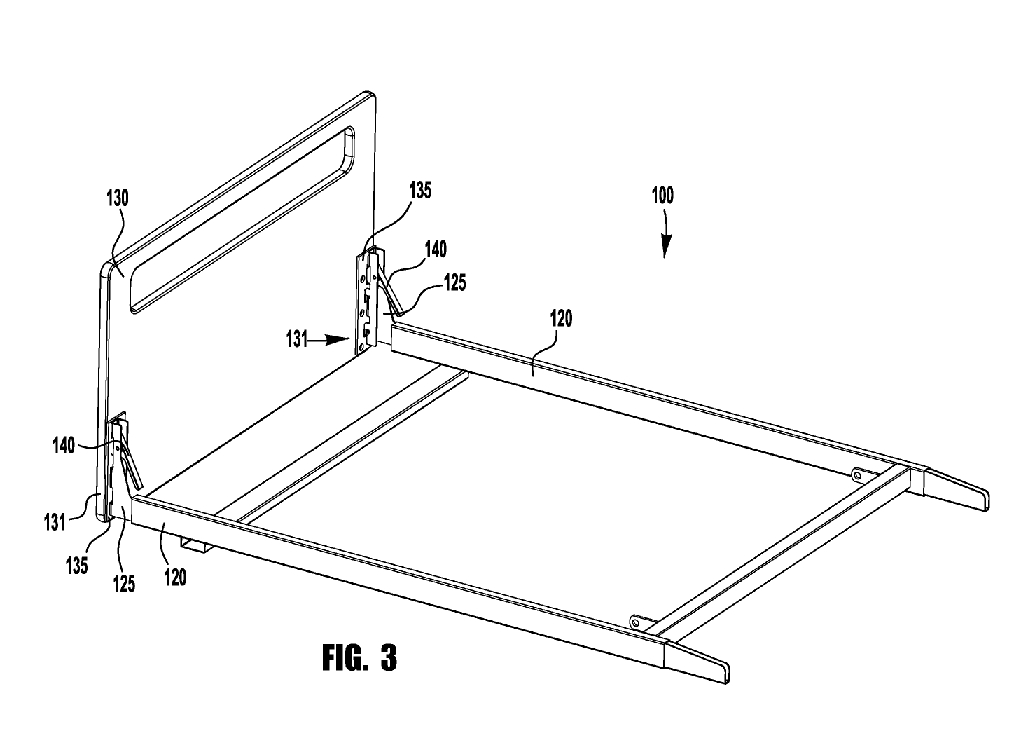

Other vertically engaging interlocking arrangements may be utilized. For example, the first frame member may be provided with a slot, and the second frame member may be provided with a tab (not shown), opposite the arrangement of the interlocking features of FIGS. 1A and 1B. In another example, one of the first and second frame members may be provided with a hook and the other of the first and second frame members may be provided with a post or other projection positioned for interlocking engagement with the hook when the first frame member is assembled with the second frame member. In the exemplary latching arrangement 10b schematically illustrated in FIGS. 2A and 2B, the first frame member 20b includes a hook portion 22b that interlocks with a post or projection 32b of a second frame member 30b in a first vertical position (FIG. 2A) to hold the first and second frame members 20b, 30b together. The hook portion 22b of the first frame member 20b disengages from the post 32b of the second frame member 30b in a second vertical position (FIG. 2B), either raised or lowered from the first vertical position, to allow separation of the first and second frame members 20b, 30b.

In the exemplary embodiments, the latch 40a, 40b is movably assembled with the first frame member 20a, 20b for horizontal movement between a locked position and an unlocked position. In the locked position, the latch 40a engages a corresponding catch portion 35a, 35b of the second frame member 30a, 30b to restrict vertical movement of the first frame member 20a, 20b with respect to the second frame member 30a, 30b. The latch may include any suitable means for latching or otherwise engaging the first frame member to the second frame member against vertical movement of the first and second frame members from the interlocking position (FIGS. 1A, 2A) to the releasing position (FIGS. 1B, 2B). In some exemplary embodiments, the latch may be biased (e.g., spring loaded) toward a locked position, for example, to inhibit inadvertent or accidental release of the latch. In other exemplary embodiments, the latch may additionally or alternatively be configured to provide a press fit or interference fit with the catch portion to resist inadvertent horizontal movement of the latch. As used herein, “horizontal movement” includes any movement that causes a portion of the latch to extend horizontally across an interface between the first and second frame members and into engagement with the catch portion. This movement may include, for example, horizontal sliding movement, vertical sliding movement, pivoting movement, rotational movement, flexing or bending movement, compressing or stretching movement, or some combination of two or more of these movements. Accordingly, the latch may include, for example, a pivoting cam (about any axis, including for example, a vertical, lateral horizontal, or longitudinal horizontal axis), sliding plunger or lever, flexible detent, or extendable screw member, or some combination of two or more of these components. In one such exemplary embodiment, a latch includes a cam member pivotable about a lateral horizontal axis between a locked position and an unlocked position.

Latching arrangements, such as the arrangements described above, may be utilized in a variety of assemblies. For example, an end member (e.g., an end board, headboard or footboard) of a bed may be detachably secured to a bed frame using one or more cam locking arrangements. In one such assembly, a latching arrangement may be secured to one of a bed frame and end member for selective locking engagement with the other of the bed frame and end member. This arrangement may, for example, minimize or eliminate the use of separate fasteners (e.g., bolts, screws), which may be lost upon detachment of the end member from the bed frame, and which may require separate tools for assembly and/or disassembly. Additionally or alternatively, the latching arrangement may be configured to provide for rigid, close fitting engagement between the bed frame and end member, thereby eliminating excessive gaps and loose engagement between the end member and bed frame.

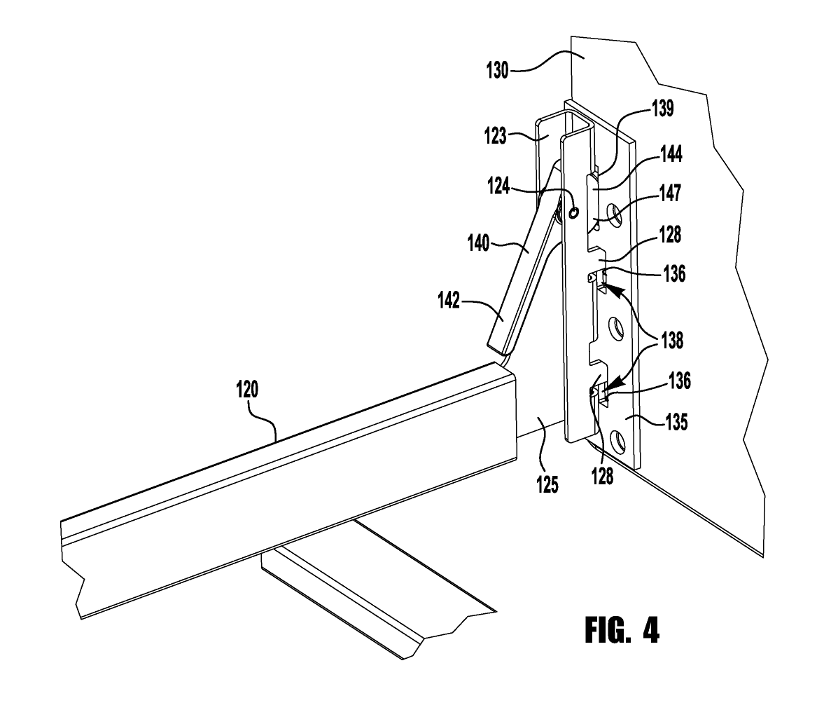

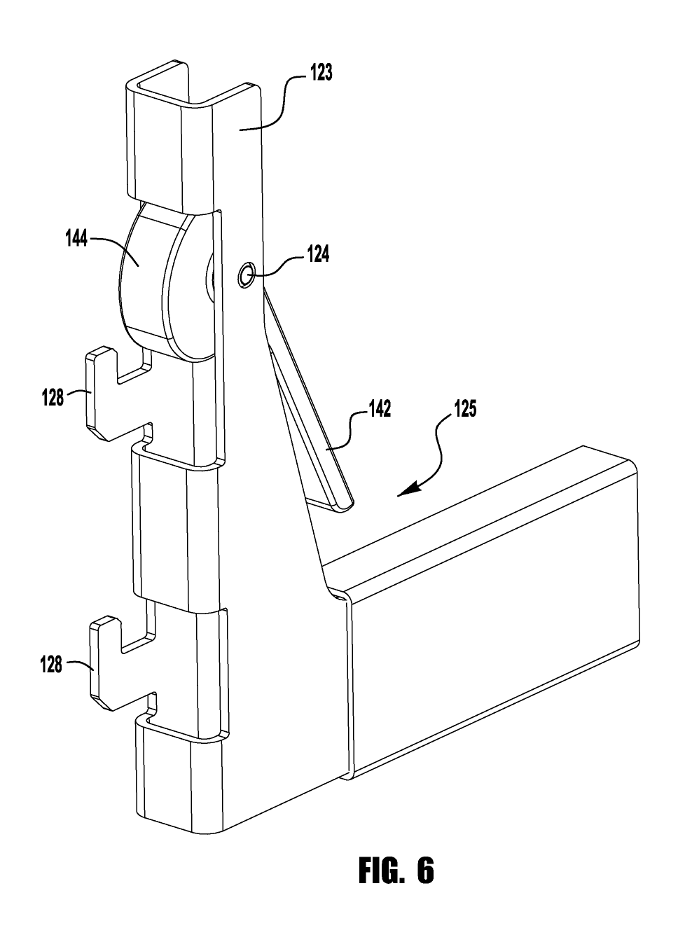

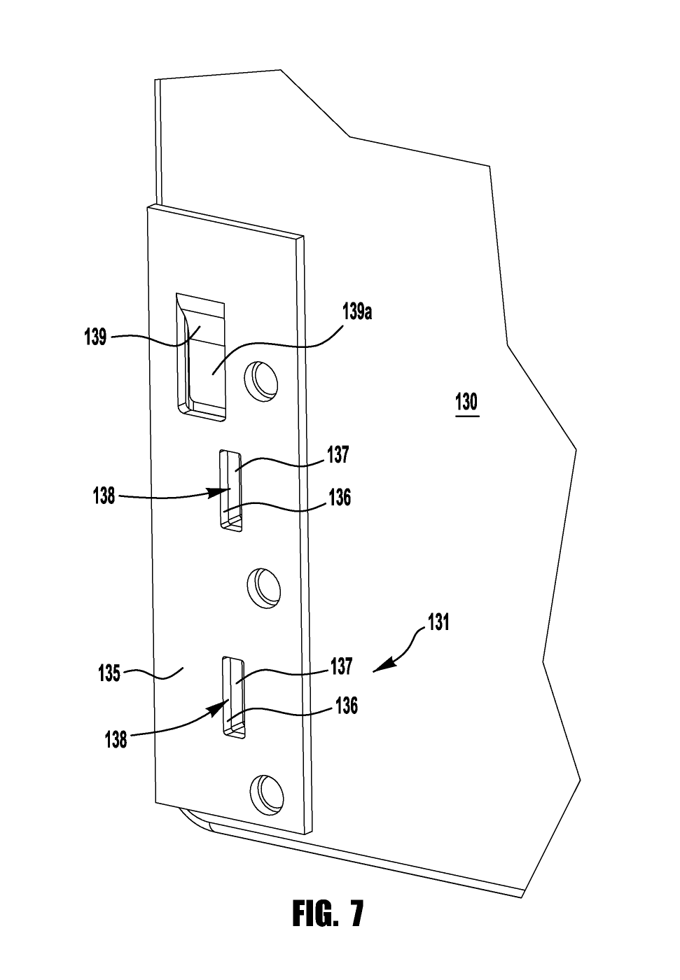

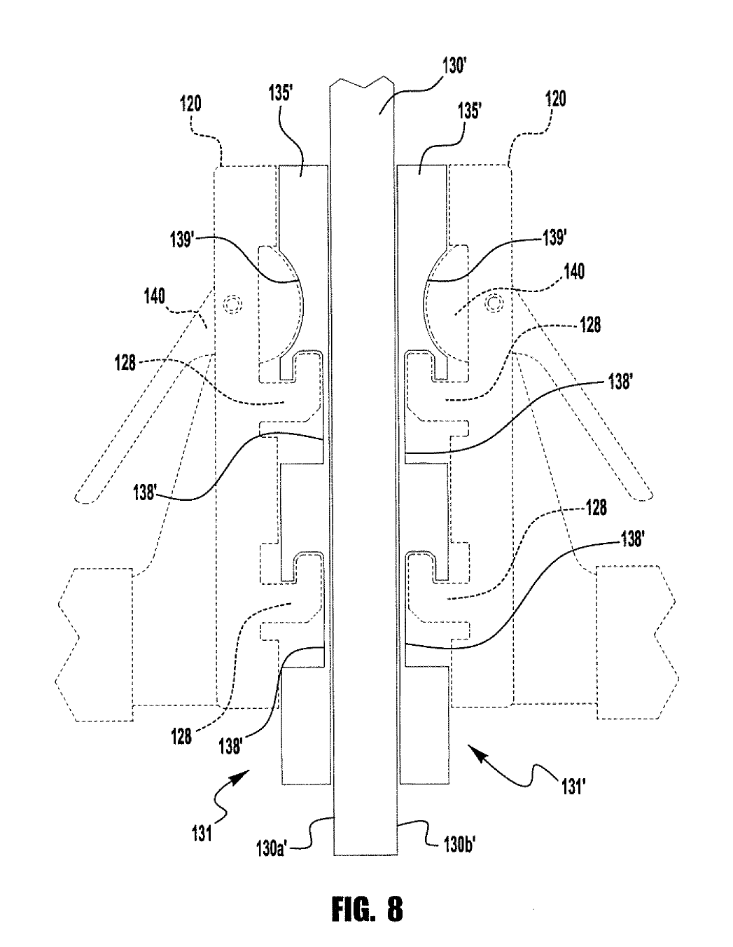

FIGS. 3-7 illustrate an exemplary bed assembly 100 including side bed frame members 120, an end board 130, and cam members 140 for releasably attaching the bed frame members 120 to the end board 130. Each bed frame member 120 includes an end bracket 125 including flanged tabs 128 (see FIGS. 5 and 6) configured to releasably engage recesses 137 in a mounting portion 131 of the end board 130. The end board 130 includes mounting plates 135 secured to a mounting portion 131 of the end board 130 (e.g., by screws, bolts, or other fasteners). As shown in the cross-sectional view of FIG. 5, each plate 135 includes openings 136 that align with recesses 137 in the mounting portion 131 to define keyed slots 138 including undercut portions 138a sized and positioned to receive the flanged tabs 128 of the corresponding bed frame member 120. The flanged tabs 128 are insertable through the plate openings 136 in a first vertical position, and movable to a second vertical position (e.g., by lifting the bed frame or by lowering the end board) for interlocking engagement with the keyed slot undercuts 138a of the end board 130.

A pivotable cam for a bed frame latching arrangement may be provided with a variety of user engageable portions to facilitate operation of the cam member, including, for example, one or more levers, buttons, knobs, or sliders. In an exemplary embodiment, a cam member includes a user graspable lever that is pressed downward to pivot the cam member to a locked condition, and pulled upward to pivot the cam member to an unlocked condition. In an alternative embodiment, a user graspable lever may be pulled upward to pivot the cam member to a locked condition, and pressed downward to pivot the cam member to an unlocked condition. In the illustrated example, each cam member 140 is pivotably connected to the corresponding end bracket 125, and includes a user engageable lever portion 142 and a horizontally extending camming portion 144. The exemplary camming portion 144 is eccentrically shaped, such that when the cam member 140 is pivoted to a locked position (pivoted downward in the illustrated example), an enlarged section 147 of the camming portion 144 is received in a recessed catch portion 139 of the end board 130, defined by the bracket 135 and the mounting portion 131. Engagement of the camming portion 144 with the catch portion 139 prevents or otherwise limits vertical movement of the end board 130 from the second vertical position to the first vertical position, thereby securing the end board 130 in interlocking engagement with the bed frame member 120. The surface of the recessed catch portion 139 may be contoured to closely receive or bear against the enlarged section 147 of the cam member 140 to further limit or prevent movement of the end board 130, providing tight engagement between the bed frame member 120 and end board 130. This contoured surface may be formed, for example, by a bent tab 139a extending from the bracket 135. When the cam member 140 is pivoted to the unlocked position, the camming portion enlarged section 147 is withdrawn from the catch portion 139, thereby allowing vertical movement of the end board 130 from the second vertical position to the first vertical position for withdrawal of the flanged tabs 128 from the keyed slots 138 and disassembly of the end board 130 from the bed frame member 120.

In another embodiment, as shown in FIG. 8, an end member 130′ that does not include formed recesses may be provided with an adapter bracket 135′ that includes keyed slots 138′ for interlocking with one or more interlocking features of a bed frame (e.g., flanged tabs 128) and a recessed catch portion 139′ for receiving an extending latch of a bed frame (e.g., cam member 140) to secure the bed frame in interlocking engagement with the end member 130′. This adapter bracket 135′ provides a mounting portion 131′ that may permit attachment of a latch-carrying bed frame (e.g., the bed frame 120 with cam member 140, as described above) to an existing end board 130′ that does not include keyed slots or latch engaging catch portions. As shown, an adapter bracket 135′ may be secured to either or both major side surfaces 130a′, 130b′ of the end member 130′, for example, to facilitate use of an end member 130′ as a universal bed end able to be assembled as either a head end or a foot end of a bed assembly. Similarly, an end member may include keyed slots and recessed catch portions at least partially integrally formed on both major side surfaces, for example, by end member recesses and mounting plates (not shown), consistent with the mounting portion 131 of the embodiment of FIGS. 3-7, for use as a universal bed end. Other arrangements and configurations for universal bed ends are described for example, in U.S. Pat. Nos. 7,302,716; 6,997.082; and 6,983,495, the entire disclosures of each of which are incorporated herein by reference.

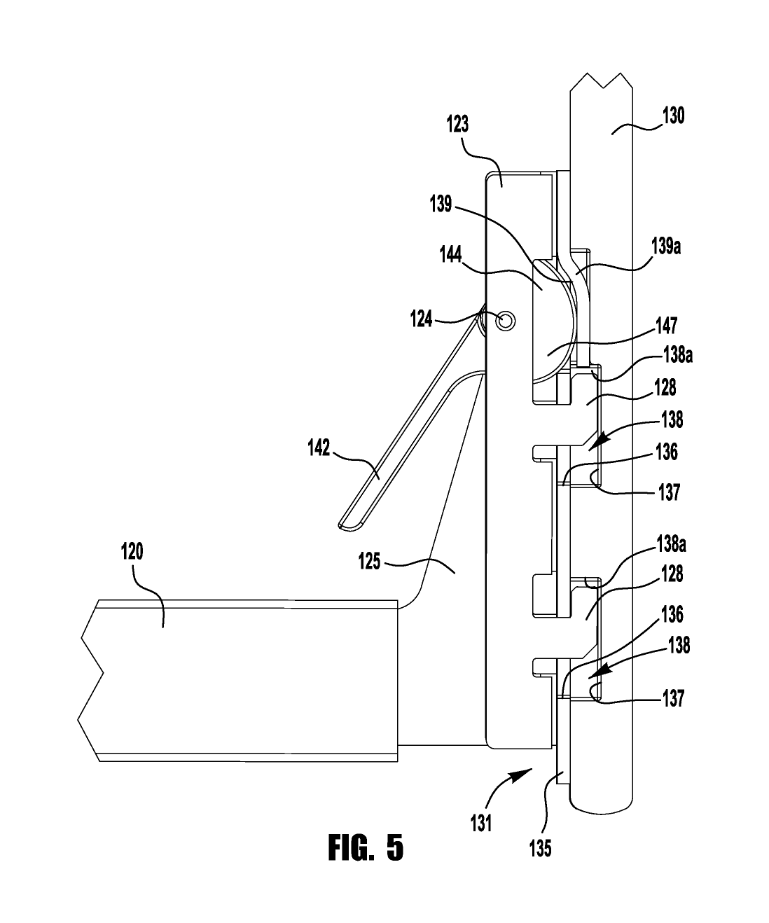

As shown in FIG. 4, the cam member 140 may be assembled to a U-shaped flange portion 123 of the end bracket 125 by a pivot pin 124 staked or otherwise secured to the sides of the flange portion 123. As such, the exemplary cam member 140 is at least partially received between opposed side walls of the U-shaped flange portion 123, for example, to protect the cam member 140 from accidental impacts or unintentional actuation.

To assemble the exemplary bed assembly 100 in accordance with an exemplary method, the end board 130 is held at a first vertical position such that the flanged tabs 128 extending from the bed frame members 120 align with the corresponding keyed slots 138 in the end board 130, and the flanged tabs are inserted into the corresponding keyed slots. The end board 130 is then lowered from the first vertical position to a second vertical position, in which the flanged tabs 128 interlock with the keyed slots 138 to secure the end board 130 to the bed frame members 120. The cam members 140 are then pivoted to the locked position, by pushing the cam lever portions 142 downward, such that the camming portions 144 engage the recessed catch portions 139 in the end board 130 to prevent movement of the end board 130 from the second vertical position to the first vertical position.

To disassemble the end board 130 from the bed frame members 120, the cam members are pivoted to the unlocked position, by pulling the cam lever portions 142 upward, such that the camming portions 144 disengage the recessed catch portions 139 in the end board 130. The bed frame member 120 is then lowered (or the end board 130 is lifted) from the second vertical position to the first vertical position to align the flanged tabs 128 with the bracket openings 136, allowing the flanged tabs to be withdrawn from the keyed slots 138 for separation of the end board from the bed frame members 120.

In accordance with an aspect of the present application, an exemplary bed frame for attaching with a bed end member includes an end bracket and a cam member pivotably secured to the end bracket. The end bracket includes a flanged tab extending from a distal interface of the end bracket for interlocking engagement with a keyed slot in the bed end member. The cam member includes a user graspable portion for pivoting the cam member between a locked position, in which an enlarged section of a camming portion of the cam member extends beyond the distal interface of the end bracket to interlock with a recess in the bed end member, and an unlocked position, in which the enlarged section is retracted with respect to the distal interface to disengage from the recess in the bed end member.

In accordance with another aspect of the present application, an exemplary bed end member for attaching with a bed frame includes a mounting portion defining at least one recess, and a latch bracket secured to the mounting portion. The latch bracket includes at least one opening that aligns with the at least one recessed to define a keyed slot having an undercut portion sized to interlock with a flanged tab extending from the bed frame. The mounting portion and latch bracket together define a recessed catch portion that is contoured to abut an arcuate camming section of a pivotable cam member assembled with the bed frame for secure engagement of the bed end member with the bed frame when the flanged tab is interlocked with the keyed slot and the cam member is pivoted to a locked position.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. An assembly comprising:
a first frame member including a first interlocking feature;
a second frame member including a second interlocking feature configured to interlock with the first interlocking feature when the second frame member is assembled with the first frame member and the second frame member is moved with respect to the first frame member from a first vertical position to a second vertical position; and
a latch secured to the first frame member and horizontally movable between a locked position in which the latch engages a catch portion of the second frame member to secure the second frame member in the second vertical position, and an unlocked position in which the latch disengages from the catch portion of the second frame member to permit movement of the second frame member to the first vertical position.

2. The assembly of claim 1, wherein the latch comprises a cam member pivotally connected to the first frame member for pivoting movement between the locked and unlocked positions.

3. The assembly of claim 2, wherein the cam member includes an eccentrically shaped camming portion.

4. The assembly of claim 2, wherein the cam member is pivotable about a horizontal axis.

5. The assembly of claim 2, wherein the cam member is pivotable about at axis substantially parallel to an interface between the first and second frame members.

6. The assembly of claim 1, wherein the first interlocking portion comprises at least one flanged tab and the second interlocking portion comprises at least one complementary shaped slot.

7. The assembly of claim 1, wherein the first frame member comprises a bed frame and the second frame member comprises an end board.

8. The assembly of claim 7, wherein the first frame member further comprises a first bracket portion joined with the bed frame and the second frame member further comprises a second bracket portion joined with the end board.

9. The assembly of claim 8, wherein the second interlocking portion comprises an opening in the second bracket portion that aligns with a recess in the end board to define a keyed slot.

10. The assembly of claim 1, wherein the first frame member includes a U-shaped flange, with the latch being at least partially retained between opposed side walls of the U-shaped flange.

11. The assembly of claim 10, wherein the latch comprises a cam member pivotable about a pivot pin secured to the opposed side walls of the U-shaped flange.

12. The assembly of claim 1, wherein the latch is secured to the first frame member in both the locked and unlocked positions.

13. The assembly of claim 1, wherein the latch includes a user operable lever.

14. A bed assembly comprising:
a bed frame including an end bracket portion having at least one flanged tab portion;
an end board including a mounting portion having at least one slotted portion configured to interlock with the at least one flanged tab portion when the end board is assembled with the bed frame and is moved with respect to the bed frame from a first vertical position to a second vertical position; and
a cam member secured to one of the bed frame and the end board, and pivotable about a horizontal axis substantially parallel to an interface between the first and second frame members between a locked position, in which the cam member engages a recess in the other of the bed frame and the end board to secure the end board in the second vertical position, and an unlocked position in which the cam member disengages from the recess to permit movement of the end board to the first vertical position.

15. The bed assembly of claim 14, further comprising a latch bracket assembled with the mounting portion of the end board to at least partially define the at least one slotted portion and the recess in the mounting portion.

16. The bed assembly of claim 14, wherein the cam member includes an eccentrically shaped camming portion.

17. The bed assembly of claim 14, wherein the first frame member includes a U-shaped flange, with the cam member being at least partially retained between opposed side walls of the U-shaped flange.

18. The bed assembly of claim 17, wherein the cam member is pivotable about a pivot pin secured to the opposed side walls of the U-shaped flange.

19. A method of releasably attaching an end board to a bed frame, the method comprising:
positioning the end board at a first vertical position such that at least one flanged tab extending from the bed frame aligns with a corresponding slotted portion in the end board;
inserting the at least one flanged tab into the corresponding slotted portion;
moving the end board from the first vertical position to a second vertical position such that the at least one flanged tab interlocks with the corresponding slotted portion to secure the end board to the bed frame;
pivoting a cam member secured to one of the bed frame and the end board to a locked position in which the cam member engages a corresponding recess in the other of the bed frame and the end board to prevent movement of the end board from the second vertical position to the first vertical position.

20. The method of claim 19, wherein moving the end board from the first vertical position to the second vertical position comprises lowering the end board such that the at least one flanged tab supports the end board.
